(19) United States
(12) Patent Application Publication
(10) Pub. No.: US 2007/0282964 A1
(43) Pub. Date: Dec. 6, 2007

(54) METHOD AND APPARATUS FOR PROCESSING REMOTE SHELL COMMANDS

(75) Inventors: George G. Behrend, New York, NY (US); Christopher V. DeRobertis, Hopewell Junction, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/422,361

(22) Filed: Jun. 6, 2006

(51) Int. Cl. G06F 15/16

(52) U.S. Cl. 709/208

(57) ABSTRACT

Methods and apparatus for processing of a distributed remote shell command are disclosed. In some embodiments, a target host receives from a client a remote shell command specifying an operation to be performed by an operating system at the target host. The target host performs the specified operation and formulates a response that has a first part containing target host identification data for the target host and a second part showing a result of performance of the specified operation. The target host issues the response to the client.

### TECHNICAL FIELD

The present invention relates generally to computer networks and software applications designed for client/server use. More particularly, the present invention relates to a system and method for providing target host identification data to a client as part of a response to a remote shell application.

### BACKGROUND OF THE INVENTION

The client/server model is a computational architecture that involves client processes (programs, typically referred to as user commands or client commands) requesting a service from one or more server processes. In a client/server architecture, a program on one computer sends a request to a program on another computer and awaits a response. For example, a client may send a request to a server and wait until a response arrives. Correspondingly, the server may wait for requests from clients, receive such a request, process the request, and return the results to the client (i.e., replies with a response). Upon receipt of the response from the server, the client may perform additional processing of the response if applicable.

Modem computing and information technology environments employ clustered and distributed computer systems that can reach to hundreds and thousands of hosts, where a host is a computer operating system (OS) image, such as using the AIX® or UNIX® operating systems. One or more distributed computer system/cluster administrators may be responsible for managing many clustered and distributed computer systems from a single point of administration (“SPOA”). It is common for such administrators to manage and monitor hosts in the distributed/clustered system through the use of a client/server remote “shell” interface (also referred to as a shell program or shell application), which is a client/server application that provides the means to open a shell on a remote target host. A shell is the interface to the operating system, and a “shell script” is a sequence of shell and operating system commands that are stored in a file. A “command” is a computer program that carries out a single operation, such as returning the current date, or multiple operations (e.g., scanning output for specific character patterns, formatting matches into multiple columns, adding the date and time to the results, and writing the results to a file). Some examples of commands available in the AIX® operating system are “date,” “dsh,” and “rsh.” Both the dsh and rsh commands, which are discussed in more detail below, arc designed to accept other commands as input and then run those commands on a remote target host.

Commands can be run in a remote shell. A remote shell is an operating shell that is opened on a remote target host through a remote shell interface. An example of a remote shell application is rsh, which contains a client portion and a server or “daemon” portion. Another example of a remote shell application is ssh (secure shell). A remote shell protocol is a particular protocol used by a remote shell application in order for the client portion to communicate with the server portion. The remote shell protocol allows a client to establish a remote shell through the server. The well known remote shell protocols and their implementations in remote shell applications (e.g., rsh/rshd in the AIX operating system, and ssh/sshd by the OpenSSH organization) are designed to have the client (the client portion of the remote shell application) contact a target host on a single server (the server portion of the remote shell application). This is referred to one-to-one processing: a client connects to one server (daemon), on one target host, at a time. Because of the one-to-one nature of remote shell programs, the client knows that the target to which the remote shell command had been sent is the source of the reply to that commands. Thus, given the one-to-one nature of known prior remote shell programs, there is no reason for the remote target host to return identifying data in response to a remote shell command.

Distributed remote shell programs allow an administrator to run the same command(s) on multiple remote target hosts through a single client-side distributed remote shell program. An example of a distributed remote shell program is the distributed shell command (dsh) by the International Business Machines Corporation of Armonk, N.Y. (IBM®). The dsh program is a user or client side program that may be used to issue remote commands from the SPOA to one, some, or all hosts in the clustered/distributed system. The dsh command issues a remote shell command for each target host specified, and returns the output from all targets, formatted so that remote command results from the targets can be managed, viewed, and/or written to a file. The dsh program essentially drives the client portion of an underlying remote shell program in an iterative manner. Thus, for a set of remote targets, dsh transmits the same command to each remote target host through the remote shell program. From the perspective of the distributed remote shell program, the distributed remote shell program is engaging in one-to-n, or one-to-many, processing, although the underlying remote shell programs (which the distributed remote shell program uses) are involved in one-to-one processing.

In order to distinguish which target returned particular results, distributed remote shell programs, such as dsh, associate a target's host name with the results of a command run in the remote shell of the target host. When dsh displays the results of the commands run in the remote shell of each target, the results can be uniquely identified as coming from a particular remote target host. This is useful for the visual inspection of the dsh program output when displayed to a console or terminal, when the output is to be processed for host-specific results, when the results are written to a file for archival purposes, and for a number of other uses where having the results of commands run in a remote shell must be associated with a particular target host. However, in known prior systems, the underlying remote shell program that is used by the distributed remote shell program does not provide target host identification data (“THID”) for each of the remote shell client/server commands issued by the distributed remote shell program. To accommodate for this lack of THID, known distributed remote shell programs may prefix host name identification data to the results after they are returned by each of the individual remote shell application invocations, but this requires performing processing on the SPOA. In the alternative, known distributed remote shell programs may add additional commands to the remote command, such as a request to display the host name of the target set, in order to receive host name data from the target host, but this changes the nature of what is being remotely run on a target.

### SUMMARY OF THE INVENTION

According to embodiments of the present invention, a client sends to a target host a remote shell command specifying an operation to be performed by an operating system at the target host. The target host performs the specified operation and formulates a response comprising a first pail containing target host identification data for the target host and a second part showing a result of performance of the specified operation. The target host issues the response to the client. In some embodiments, the received remote shell command may include a flag that requests that the target host include target host identification data. In other embodiments, the response to the remote shell command may be automatically formulated to include target host identification data regardless of the operation that is specified by the remote shell command. In embodiments, such target host identification data is provided by the target host even though the remote shell command is received at the target host from the client, and the response is issued from the target host to the client, via a remote shell one-to-one connection between the target host and the client. In further embodiments, the response may be a single line of output that includes the first part containing target host identification data and the second part showing the result of the specified operation. In some embodiments, the client may display one or more responses received, with each response displayed on a single line that includes the first part containing target host identification data and the second part showing a result of the operation specified in the remote shell command.

The invention and its embodiments will be more fully appreciated by reference to the following detailed description of illustrative embodiments in accordance with the present invention when taken in conjunction with the accompanying drawings.

### BRIEF DESCRIPTION OF THE DRAWINGS

FIG. 1 is a block diagram showing an example of a system performing a remote shell command so that target host identification data is returned to the client according to an embodiment of the invention.

FIG. 2 is a flow chart showing an example of a method of processing a remote shell command according to an embodiment of the invention.

FIG. 3 is a block diagram showing a system including a client and a plurality of remote target hosts performing a distributed remote shell command according to an embodiment of the invention.

FIG. 4 is a block diagram showing further details of an example of a client system and a remote target host system according to an embodiment of the invention.

FIG. 5 is a block diagram showing a computer readable medium with program code for processing a remote shell command at a target host system according to an embodiment of the invention.

### DETAILED DESCRIPTION

The present invention provides a system and method for providing the automatic inclusion of target host identification data prefixed to the output results that are returned to a client in a client/server remote shell application. Embodiments of the present invention reduce the performance implications and resource consumption of associating and maintaining THID in distributed remote shell programs. In particular embodiments, the present invention may be applied to the dsh program so as to associate and maintain the THID for each of the remote shell operations initiated by the dsh program. By having the THID transmitted by the server as part of its normal output stream, embodiments of the present invention improve the one-to-n (many) performance of the THID by off-loading the existing distributed remote shell program's prefixing of the THID to the target's output. When such embodiments of the invention are employed, the dsh program (in particular) and distributed remote shell programs (in general) do not incur the costs of creating, maintaining, and associating the THID. Similarly, for users that would otherwise explicitly request THID as part of the command set, returning the THID as part of the default results eliminates the need for users to explicitly and manually request such data.

Embodiments provide for a cluster/distributed systems administrator and/or user to specify when a remote shell application should or should not automatically return the THID, for example by including in a remote shell command a flag that requests that the target host include THID. In such embodiments, the user may have specified an option (flag) to the client that instructs the server to return THID. In some embodiments, the remote shell application on the sever side may or may not be configured to return THID. In such embodiments, receipt of a flag by the remote shell application at the server may only cause the return of THID when the remote shell application server has been configured to return THID; otherwise, the server may ignore the flag and no THID is returned to the client. In some embodiments, the server is configured to “always” return THID, whether or not a client requests THID. In this case, THID may be returned regardless of whether the user does or does not include a flag requesting the return THID in the remote shell command. Thus, the response to the remote shell command may be automatically formulated to include target host identification data regardless of the operation that is specified by the remote shell command. In some embodiments, the response containing target host identification data is returned as part of the remote shell operation. For the case when THID is to be returned, an administrator can specify the types and formats of the THID returned. In some embodiments, the remote shell command is received at the target host from the client, and the response is issued from the target host to the client, via a remote shell one-to-one connection between the target host and the client. In some embodiments, the response comprises a single line of output that includes a first part containing target host identification data and a second part showing the result of the specified operation. While the following description provides examples of embodiments, the appended claims cover all modifications and changes that fall within the true spirit and scope of the invention.

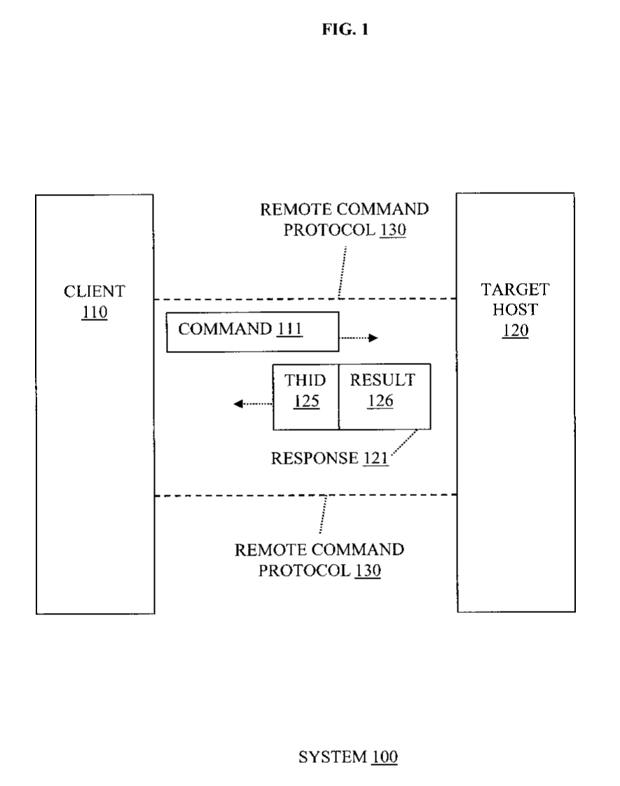

FIG. 1 is a block diagram showing an example of client/server performing a remote shell application so that target host identification data is returned to the client according to an embodiment of the invention. FIG. 1 shows a system 100 that includes a client 110 and a target host 120 that are coupled together by a remote command protocol 130. As discussed above, a host such as target host 120 is a computer operating system image. In some embodiments, client 110 and target host 120 may each be any types of information handling systems, such as a personal computer, workstation, minicomputer, mainframe, laptop, personal digital assistant, etc. For example, either client 110 or target host 120 may be a UNIX-based system running AIX. In some embodiments, client 110 or target host 120 are both part of the same computing device. For example, client 110 and target host 120 may be operating system images that are both running on the same computing device.

In embodiments, client 110 and target host 120 are coupled to each other over a network, such as a local area network (LAN), wide area network (WAN), intranet, internet, etc. Remote command protocol 130, shown in FIG. 1, is a logical connection that may be created over the network(s) connecting client 110 and target host 120 to implement a remote shell. As discussed above, a shell is the interface to the operating system, and a remote shell is an operating shell that is opened on a remote target host through a remote shell interface. As would be well understood by persons of skill in the art, a remote shell may be established using a remote shell protocol, such as rsh, a Transmission Control Protocol (TCP) that uses TCP port 514, or ssh, a TCP that uses TCP port 22. FIG. 1 shows a command 111 that is being sent from client 110 to target host 120 over remote command protocol 130. For example, command 111 may be a rsh command that contains an argument specifying an operation to be performed on the remote target host. To further specify this example, command 111 might be “rsh xyz.com ls”, which logs on to xyz.com (the target host) and processes the ls command, which is a UNIX® command to list the contents of a directory (in the target host). Of course, any other operating system commands, for any operating system, may be specified as the object of a remote system command.

FIG. 1 shows a response 121 that is being sent from target host 120 to client 110 over remote command protocol 130. In the example shown in FIG. 1, response 121 would be a response to command 111. As shown in FIG. 1, response 121 includes target host identification data 125 as a first part and result 126 as a second part. Following on the example above, where command 111 was “rsh xyz.com ls”, then result 126 may be a list of the contents of the current directory on target host 120. Target host identification data 125 may be the host name for remote target host 120 and may be prefixed to the result 126 to form the response 121 that is sent to client 110 as a result of performing the operations specified by command 111. Some examples of types of target host identification data 125 and formats that may be provided are the fully qualified host name, short host name, IPv4 address, IPv6 address, date as set on the target host (and returned in one of several possible date formats), time as set on the target host (and returned in one of several possible time formats), custom text file (return the contents of a text file as the THID), or custom program (a program is automatically run and the results returned as the THID).

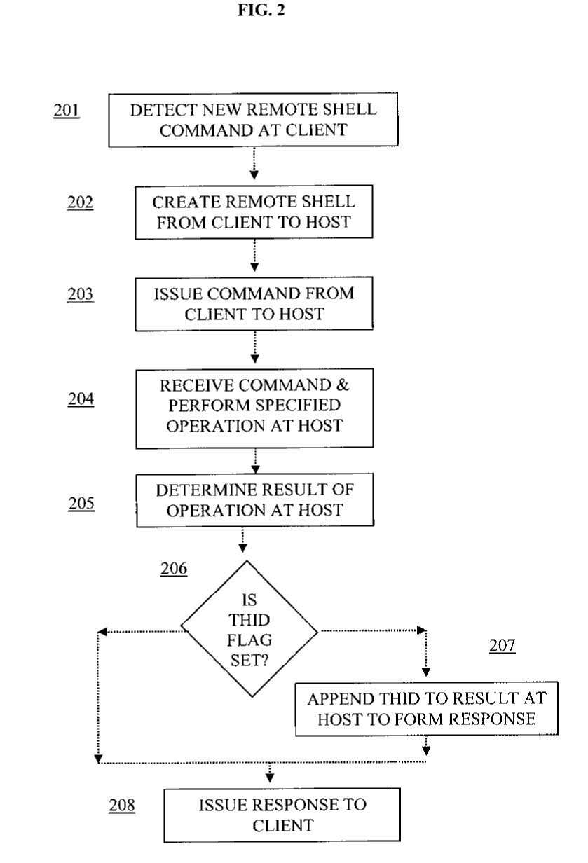

FIG. 2 is a flow chart showing an example of a method of processing a remote shell command according to an embodiment of the invention. As shown in the example of FIG. 2, a client such as client 1 10 detects a new remote shell command (201). For example, a user on client 110 may have issued a remote shell command on client 110, such as an rsh command that specifies an operation to be performed (e.g., ls) and a target host that is to perform this operation (e.g., target host 120). As shown in FIG. 2, the client 110 may then request a remote shell, such as remote command protocol 130, between the client and the target host (202). In this example, client 110 establishes a one-to-one logical connection with target host 120 over remote command protocol 130. The client may then issue the command to the target host over the remote shell (203), as shown by command 111 in FIG. 1. The target host may then receive the command and perform the specified operation (204). For example, the target host may receive the remote shell command rsh that specifies the operation “ls” to be performed. The remote target host may then determine the results of the operation (205), which may be sent with a response to the client. In accordance with the ls UNIX command, the remote target host may then determine which files are in the current directory at the remote target host. In this example, the remote target host may respond that one or more files are present in the current directory, and may prefix the host name to the response. In some embodiments, the remote target host may determine if the remote shell command contains a flag that indicates that THID should be returned by the remote target host (206), and if this flag is set the remote target host prefixes THID to the result of the operating system command to form a response (207). The host may then issue the response to the client (208), as represented by response 121 in FIG. 1. As discussed above, in other embodiments, the THID may be automatically prefixed to responses to any remote shell command.

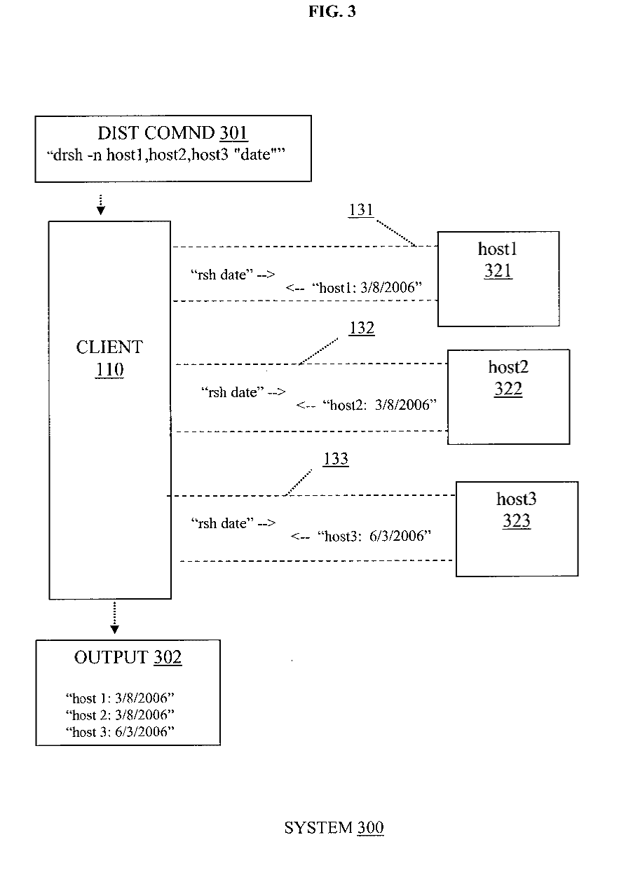

FIG. 3 is a block diagram showing a system 300 including a client and remote target host performing a distributed remote shell command according to an embodiment of the invention. The example distributed remote command is merely an example only and does not imply any relationship to remote shell commands that might have the name DRSH. FIG. 3 shows client 110 of FIG. 1 coupled by remote command protocols (131-133) to remote target host1 (321)-host3 (323), which each may be instances of target host 120 of FIG. 1. Similarly, remote command protocol 131—remote command protocol 133 each may be instances of remote command protocol 130 of FIG. 1. While this example shows that the remote shell command is being provided to three remote target hosts, in other embodiments the client may process a distributed remote shell command that specifies any number of hosts as objects of the command. For example, the SPOA may be maintaining 1000 remote target hosts that are coupled to client 110 and may wish to send a remote shell command to each of those 1000 remote target hosts. FIG. 3 shows client 110 receiving distributed remote shell command 301, which in the example shown is the command “drsh-n host1,host2,host3 “date”.” This command may have been submitted to client 110 by a user of client 110 (e.g., typed in by the user). The command “drsh host1-host3 date” is an example of a distributed remote target host command that requests client 110 to send the command “date” as a remote shell command to each of hosts1 to host3. The command “date” requests that the target host provide the current date as maintained at that target host. In this example, the SPOA at client 110 may have wanted to determine if each of remote target host1-host3 are set with the correct current date.

As discussed above, and per typical processing for distributed remote shell commands, FIG. 3 shows the remote shell command “rsh date” being sent by client 110 through each of remote shells 131-133 to each of host1-host 3 (321-323). These commands are represented by command 111 in FIG. 1. As discussed above, upon receipt of the remote shell command, each of host1-host 3 (321-323) may perform the “date” command and formulate a result, which would require determining the current date that is maintained at that remote target host and providing that date as an output. According to embodiments of the present invention, as part of performing the “rsh” command at each remote target host, each remote target host may prefix the host name (e.g., “host1”) to the output that is to be provided in response to the remote shell command. Thus, FIG. 3 shows that host1 321 sends a response “host1: 3/8/2006”, host2 322 sends a response “host2: 3/8/2006”, and host3 323 sends a response “host3: 6/3/2002”. These responses are represented in FIG. 1 as response 121. In the example shown in FIG. 3, host3 is set at and returns a different date than host1 and host2.

After receipt of one or more responses to the remote shell commands, client 110—may provide the received responses as output 302. For example, client 110 may display each response on a screen, write each response to a file that may be printed, etc. In some embodiments, client 110 may provide each response as output upon receipt, without waiting for other responses from other remote target hosts. As shown in the example of FIG. 3, client 110 outputs:

host 1: 3/8/2006

host2: 3/8/2006

host3: 6/3/2002

The SPOA at client 110 may then review the output 302 and determine that host3 is set at the wrong date. Note that in this example, each line of the output 302 starts with the host name, which enables the user to determine which host sent that response. According to embodiments of the present invention, this host name was prefixed to the response at the host as part of the protocol for responding to remote shell commands.

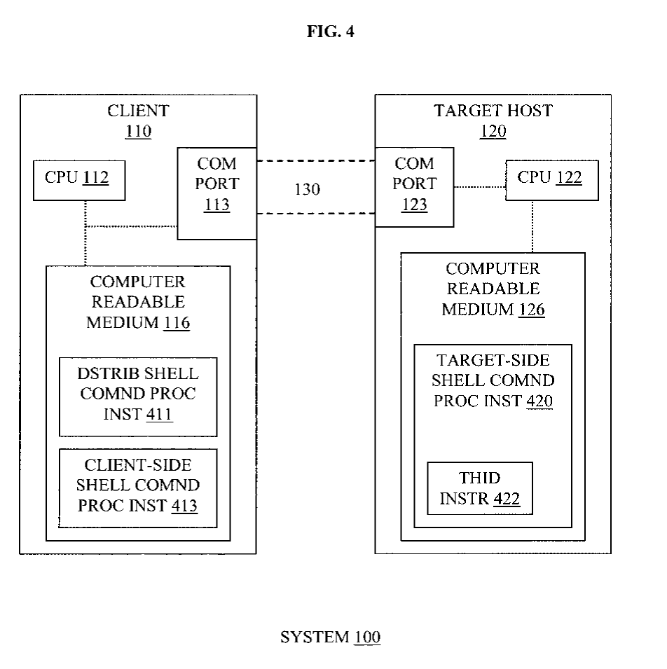

FIG. 4 is a block diagram showing part of system 100 of FIG. 1 that includes further details of an example of a client 110 and a remote target host 120 according to an embodiment of the invention. In FIG. 4, client 110 includes a central processing unit (CPU) 112, a communications port 113, and a computer readable medium 116, all of which are coupled together by a bus. Similarly, client 120 is shown as including a CPU 122, a communications port 123, and a computer readable medium 126, all of which are coupled together by a bus. The CPUs 112 and 122 may be any types of central processing units, and communications ports 113 and 112 may be any types of communications ports for sending or receiving information at client 110 and target host 120, such as for example an Ethernet port. In embodiments, network adapters may be coupled to client 110 or target host 120 to couple them to other data processing systems or remote printers or storage devices through intervening private or public networks. Modems, cable modems and Ethernet cards are just a few of the currently available types of network adapters. In FIG. 4, remote command protocol 130, which as discussed above may be a logical connection that may be created over one or more networks, is coupled on one side to communication port 110 and on the other side to communications port 123 of target host 120. Of course, these are just examples of the components of client 110 and target host 120, and in other embodiments client 110 and/or target host 120 may contain more, less, or additional components. For example, client 110 and target host 120 may also include one or more of a system memory (such as a Random Access Memory and/or Read Only Memory) and a mass storage device (such as a disk drive), which may be coupled together over one or more busses. Similarly, input/output or I/O devices (including but not limited to keyboards, displays, pointing devices, etc.) may be coupled to one or both systems either directly or through intervening I/O controllers.

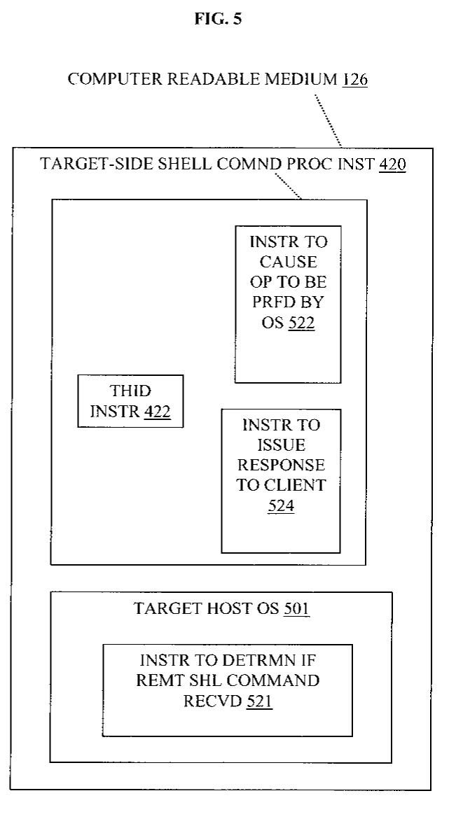

In embodiments, the present invention may be used with a data processing system suitable for storing and/or executing program code, of which client 110 and target host 120 are examples, and which may include at least one processor coupled directly or indirectly to memory elements (or other computer useable media or computer readable media) through a system bus. The memory elements may include local memory employed during actual execution of the program code, bulk storage, and cache memories which provide temporary storage of at least some program code in order to reduce the number of times code must be retrieved from bulk storage during execution. As discussed in more detail below and in reference to FIG. 5, embodiments of the present invention may take the form of a computer program product accessible from a computer-usable or computer-readable medium (such as computer readable medium 116 and/or computer readable medium 120) providing program code for use by or in connection with a computer or any instruction execution system (such as by CPU 112 and/ or CPU 122). For the purposes of this description, a computer-usable or computer readable medium can be any apparatus that can contain, store, communicate, propagate, or transport the program for use by or in connection with the instruction execution system, apparatus, or device. Computer readable 116 and computer readable medium 126 may be an electronic, magnetic, optical, electromagnetic, infrared, or semiconductor system (or apparatus or device) or a propagation medium. Examples of such computer-readable mediums include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. In such embodiments, the present invention may be implemented in software, which includes but is not limited to firmware, resident software, microcode, etc. Other embodiments of the invention may take the form of an entirely hardware embodiment, an entirely software embodiment or an embodiment containing both hardware and software elements.

FIG. 4 shows computer readable medium 116 of client 110 storing distributed shell command processing instructions 411 and client side shell command processing instructions 413. In embodiments, distributed shell command processing instructions 411 are all or part of a program that executes distributed remote shell commands. Such a program may be part of an operating system at client 110 or may receive input from such an operating system, which may have determined that a distributed remote shell command is to be processed. As discussed above, distributed shell command processing instructions 411 may execute one or more remote shell commands that are specified. Distributed shell command processing instructions 411 may fork a remote shell process for each remote target host that is specified in the remote shell command. These processes may be executed by client side shell command processing instructions 413, which for each remote target host may create a remote shell (such as remote command protocol 130) and may send the specified distributed remote shell command to the remote target host.

Similarly, FIG. 4 shows computer readable medium 126 of target host 120 storing target-side shell command processing instructions 420, which include target host identification data processing instructions. FIG. 5 is a block diagram showing the same computer readable medium 126 and showing further details of target-side shell command processing instructions 420 according to an embodiment of the invention. In this example, target-side shell command processing instructions 420 comprises program code for processing a remote shell command at target host system 120. Target-side shell command processing instructions 420 may be the server or “daemon” portion of a remote shell application such as rsh. As shown in FIG. 5, computer readable medium 126 is also shown storing target host operating system instructions 501. In some embodiments, upon operating system instructions 501 receiving a remote shell command from a client, operating system instructions 501 may determine that the command is a remote shell command and may cause target-side shell command processing instructions 420 to execute the remote shell command. As shown in FIG. 5, operating system instructions 501 includes instructions to determine that a remote shell command was received 521.

As shown in FIG. 5, target-side shell command processing instructions 420 includes computer useable product code such as instructions to cause the remote shell operation to be performed by the operating system 522, target host identification data instructions 422, and instructions to issue a response to the client 524. In some embodiments, target-side shell command processing instructions 420 processes a remote shell command by determining what underlying operation or operations are specified by the remote shell command (e.g., the ls operation) and whether any options are specified in the remote shell command. As would be understood by persons in the art, the instructions to cause the remote shell operation to be performed by the operating system 522 would cause operating system instructions 501 to perform that underlying remote shell command, and the operating system instructions 501 would generate a result, such as an indication that the operation had been preformed, could not be performed due to an error condition, and/or some data that was requested to be returned by the operation. In the example above, the operating system 501 would perform the ls instruction and would return a list of the files in the current directory. In some embodiments of the invention, target-side shell command processing instructions 420 would then formulate a response to the remote shell command, which in this example would include the list of files in the current directory. According to embodiments of the present invention, target host identification data instructions 422 prefix target host identification data to this response. As discussed above, the addition of such THID to the response may be automatic as part of the remote shell protocol or may occur upon the determination that an option has been selected in the remote shell command. In some embodiments, the type of remote shell data that is returned may be included as part of the options sent in the remote shell protocol. Instructions to issue a response to the client 524 may then issue this response to the client 110 as discussed above.

According to embodiments of the invention, Cluster Systems Management (CSM) software provides a distributed remote shell program that uses underlying remote commands that are on the operating system. Execution is distributed to one or more remote target hosts through an external remote shell program (e.g., AIX rsh, OpenSSH), with an enhancement that allows the option to prepend each line of output with the name of the remote target host where execution is taking place (i.e., the target host). Such support may be provided by any remote shell programs included with an operating system (e.g., rsh with AIX) or in third-party remote shell programs (e.g., OpenSSH). With this function a distributed command execution tool (such as IBM CSM dsh) could exploit the invention to offload output processing to a remote shell command instead of processing the output itself, thus resulting in improved execution time and reduced memory utilization (as a buffer or array is no longer required to process the remote shell output). Laboratory tests have indicated that the use of this invention could result in significant resource savings (memory and processing time) related to the output processing time otherwise required for the client to prepend such target host identification data.

In some embodiments of the present invention, a switch/flag/directive (-P, for example) may be supplied to the remote shell client and sent to the remote server daemon. The directive (e.g., -P) may instruct the server daemon to prepend each line of output sent to the client with the server daemon's host name. The inclusion of the hostname in the output processing may then be performed on the remote system versus the client, which may save local resources. An example in the case of the rsh command, as would be appreciated by a person of skill in the art, might be: “# rsh host1 -P who”, which might provide the following output:

| | |
|---|---|
| host1: admin: 0 | Sep 15 07:22 |
| host1: sven pts/2 | Sep 15 10:55 |
| host1: laura pts/3 | Sep 15 10:55 |
| host1: jill pts/4 | Sep 15 10:56 |

In this example, rather than dsh itself owning the costly responsibility for intercepting, processing, and prepending the remote target host name, the underlying rsh server daemon on the remote target hosts adds the remote target host name to the output it sends to its requesting client, thus saving substantial processing time in dsh. This is significant because the output processing is offloaded from the host where dsh is run (i.e., a single host) to the each cluster host responsible for providing the results. Another example might be “# dsh -n host[1-2000] -o “-P” who”, which as would be appreciated by a person of skill in the art, might provide the following output:

| | |
|---|---|
| host1: admin: 0 | Sep 15 07:22 |
| host1: sven pts/2 | Sep 15 10:55 |
| host1: laura pts/3 | Sep 15 10:55 |
| host1: jill pts/4 | Sep 15 10:56 |
| host2: rover: 0 | Sep 15 07:22 |
| host2: fluffy pts/2 | Sep 15 10:55 |
| host2: tessa pts/3 | Sep 15 10:55 |
| host2: kiara pts/4 | Sep 15 10:56 |
| host2: ned pts/6 | Sep 15 09:33 |
| . . . | |
| host2000: admin: 0 | Sep 15 07:22 |
| host2000: aybabtu pts/2 | Sep 15 10:55 |

In this example, dsh recognizes the presence of -P and suppresses its own output processing, and relies on the output of rsh. Note, however, that this is only an example of possible implementation with dsh. It is not the intent to impose an implementation on dsh.

According to the embodiments of the present invention, optional data is added to a service's output stream to provide a means to automatically include additional host-identification data prefixed to the output (results) provided by a server. The server may be, for example, a remote shell service of the BSD r command rsh style (remote shell) or a remote secure shell of the Secure Shell (ssh) protocol standard. According to embodiments, the servers are “windows” or interfaces to remote systems, whereby the rsh or ssh style clients provide a remote shell interface, and where users send one or more operating system, shell, or other program invocation to the remote shell.

The present invention is not limited to a particular distributed shell implementation. Embodiments of the present invention can be generalized to any distributed shell program that calls a remote shell client program, such as for example the BSD rsh or OpenSSH's ssh (secure shell). As will be appreciated, embodiments of the present invention are also not limited to any particular physical or virtual devices or to a particular network and may be applied, for example, over any Internet Protocol-based (IP) network (small-area network, wide-area network, wireless network, virtual network, etc.). Any disclosed embodiment may be combined with one or several of the other embodiments shown and/or described. This is also true for one or more features of the embodiments. While the invention has been described in detail herein in accordance with certain embodiments thereof, many modifications and changes therein may be effected by those skilled in the art. Accordingly, it is intended by the appended claims to cover all such modifications and changes as fall within the true spirit and scope of the invention.

What is claimed is:

1. A method comprising:
receiving a remote shell command at a target host from a client, the received remote shell command specifying an operation to be performed by an operating system at the target host;
performing the specified operation at the target host;
formulating a response at the target host, the response comprising a first part containing target host identification data for the target host and a second part showing a result of performance of the specified operation; and
issuing the response from the target host to the client.

2. The method of claim 1, wherein the received remote shell command includes a flag that requests that the target host include target host identification data.

3. The method of claim 1, wherein the response to the remote shell command is automatically formulated to include target host identification data regardless of the operation that is specified by the remote shell command.

4. The method of claim 1, wherein the response containing target host identification data is returned within the remote command protocol as part of the output response.

5. The method of claim 1, wherein the response comprises a single line of output that includes the first part containing target host identification data and the second part showing the result of the specified operation.

6. The method of claim 1, wherein the remote shell command is received at the target host from the client, and the response is issued from the target host to the client, via a remote shell one-to-one connection between the target host and the client.

7. A computer program product comprising a computer-readable medium having stored thereon instructions which, upon execution by a processor, will cause the processor to perform a method comprising:
receiving a remote shell command at a target host from a client, the received remote shell command specifying an operation to be performed by an operating system at the target host;
causing the specified operation to be performed at the target host;
formulating a response at the target host, the response comprising a first part containing target host identification data for the target host and a second part showing a result of performance of the specified operation; and
issuing the response from the target host to the client.

8. The computer program product of claim 7, wherein the received remote shell command includes a flag that requests that the target host include target host identification data.

9. The computer program product of claim 7, wherein the response to the remote shell command is automatically formulated to include target host identification data regardless of the operation that is specified by the remote shell command.

10. The computer program product of claim 7, wherein the response containing target host identification data is returned within the remote command protocol as part of the output response.

11. The computer program product of claim 7, wherein the response comprises a single line of output that includes the first part containing target host identification data and the second part showing the result of the specified operation.

12. The computer program product of claim 7, wherein the remote shell command is received at the target host from the client, and the response is issued from the target host to the client, via a one-to-one connection between the target host and the client.

13. A computer program product comprising a computer-readable medium having stored thereon instructions which, upon execution by a processor, will cause the processor to perform a method comprising:
determining at a client that a distributed remote shell command is to be performed, wherein the distributed remote shell command specifies a command and a plurality of target hosts; and
processing the command on the client for each of the plurality of target hosts, wherein for each of the target hosts processing the command on the client comprises:
establishing a remote command protocol between the client and the target host;
issuing the command to that target host within the remote command protocol as a remote shell command; and
receiving at the client a response to the command from that target host, wherein that response comprises a first part containing target host identification data for that target host and a second part showing a result of an operation specified in the command.

14. The computer program product of claim 13, wherein the command includes a flag that requests that the target host include target host identification data.

15. The computer program product of claim 13, wherein the target host identification data comprises the host name for the target host.

16. The computer program product of claim 13, wherein the method further comprises displaying at the client one or more responses received, wherein each such response displayed is displayed on a single line, and where each such response displayed includes the first part containing target host identification data and the second part showing a result of the operation specified in the remote shell command.

17. The computer program product of claim 13, wherein the distributed remote shell command is a dsh command.

18. The computer program product of claim 13, wherein the response containing target host identification data is returned within the remote command protocol as part of the output response.
